(19) United States
(12) Patent Application Publication
(10) Pub. No.: US 2024/0329567 A1
(43) Pub. Date: Oct. 3, 2024

(54) IMAGE FORMING APPARATUS

(71) Applicant: FUJIFILM Business Innovation Corp., Tokyo (JP)

(72) Inventor: Yoshiyuki TOMINAGA, Kanagawa (JP)

(73) Assignee: FUJIFILM Business Innovation Corp., Tokyo (JP)

(21) Appl. No.: 18/357,519

(22) Filed: Jul. 24, 2023

(30) Foreign Application Priority Data
Mar. 27, 2023 (JP) 2023-050272

(51) Int. Cl. G03G 15/16

(52) U.S. Cl. CPC G03G 15/1605

(57) ABSTRACT

An image forming apparatus includes: a transfer unit configured to transfer an image to an object by coming into contact with the object; a mounting table on which the object is to be mounted; a transporting unit configured to transport the mounting table along a transport path; and a lift capable of changing a height of the mounting table and configured to adjust the height of the mounting table in a process of image transfer to the object by the transfer unit, the lift adjusting the height of the mounting table such that a leading part, in a direction of transport, of the object mounted on the mounting table transported by the transporting unit comes into contact with the transfer unit at a position of the transport path, the position being on an upstream side in the direction of transport relative to a position where any other part of the object comes into contact with the transfer unit.

### CROSS-REFERENCE TO RELATED APPLICATIONS

This application is based on and claims priority under 35 USC 119 from Japanese Patent Application No. 2023-050272 filed Mar. 27, 2023.

### BACKGROUND

### Technical Field

The present disclosure relates to an image forming apparatus.

### Related Art

Objects of image printing in recent years include various media having different thicknesses and shapes, such as metal, glass, and tiles.

A printer disclosed by Japanese Patent No. 3292954 is configured to form an image on a disc mounted on a transporting table while transporting the disc and the transporting table altogether.

### SUMMARY

In electrophotographic printing of an image on a hard medium such as metal, if image transfer is started at the moment when the medium reaches a transfer unit, the impact at the contact of the medium with the transfer unit or the fluctuation in the nipping force makes the transfer electric field on the printing surface of the medium unstable. Such a situation may trigger defective transfer, leading to nonuniformity in the density of the image printed on the medium.

Aspects of non-limiting embodiments of the present disclosure relate to electrophotographic printing and to reducing the probability of deterioration in image quality that may be caused by the impact occurring at the contact of a medium with a transfer unit or the fluctuation in the nipping force, compared with a case where image transfer is started at the moment when the medium reaches the transfer unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a transfer unit configured to transfer an image to an object by coming into contact with the object; a mounting table on which the object is to be mounted; a transporting unit configured to transport the mounting table along a transport path; and a lift capable of changing a height of the mounting table and configured to adjust the height of the mounting table in a process of image transfer to the object by the transfer unit, the lift adjusting the height of the mounting table such that a leading part, in a direction of transport, of the object mounted on the mounting table transported by the transporting unit comes into contact with the transfer unit at a position of the transport path, the position being on an upstream side in the direction of transport relative to a position where any other part of the object comes into contact with the transfer unit.

### BRIEF DESCRIPTION OF THE DRAWINGS

An exemplary embodiment of the present disclosure will be described in detail based on the following figures, wherein:

FIG. 1 illustrates a configuration of an image forming apparatus to which the present exemplary embodiment is applied;

FIG. 2 illustrates a configuration of a transfer unit;

FIG. 3A illustrates a behavior of a transporting mechanism before the transfer unit starts image transfer, specifically illustrating a state where height control is underway;

FIG. 3B illustrates the behavior of the transporting mechanism, specifically illustrating a state where the transporting mechanism is retracted to a standby position after height control;

FIG. 3C illustrates the behavior of the transporting mechanism, specifically illustrating a state where the transfer unit starts image transfer;

FIG. 4A illustrates an exemplary operation of height control for a mounting table by using a lift, specifically illustrating media having different heights;

FIG. 4B illustrates the exemplary operation of height control, specifically illustrating the media each aligned at a transfer-execution height by the lift;

FIG. 5 illustrates an example of a first contact position;

FIG. 6 illustrates another example of the first contact position;

FIG. 7A is a side view of a passive mechanism, illustrating an exemplary configuration of a seat;

FIG. 7B is a bottom view of the passive mechanism, illustrating the exemplary configuration of the seat;

FIG. 8A is a side view of an active mechanism, illustrating an exemplary configuration of the seat;

FIG. 8B is a bottom view of the active mechanism, illustrating the exemplary configuration of the seat;

FIG. 9A illustrates a behavior of one example of the seat in an operation of transfer, specifically illustrating a state at the contact of a medium with an intermediate transfer belt;

FIG. 9B illustrates the behavior of the one example of the seat, specifically illustrating a state at the start of transfer;

FIG. 9C illustrates the behavior of the one example of the seat, specifically illustrating a state where transfer is in progress;

FIG. 9D illustrates the behavior of the one example of the seat, specifically illustrating a state at the end of transfer;

FIG. 9E illustrates the behavior of the one example of the seat, specifically illustrating a state at the leaving of the medium from the intermediate transfer belt;

FIG. 10A illustrates a behavior of another example of the seat in the operation of transfer, specifically illustrating a state at the contact of a medium with the intermediate transfer belt;

FIG. 10B illustrates the behavior of the other example of the seat, specifically illustrating a state at the start of transfer;

FIG. 10C illustrates the behavior of the other example of the seat, specifically illustrating a state where transfer is in progress;

FIG. 10D illustrates the behavior of the other example of the seat, specifically illustrating a state at the end of transfer;

FIG. 10E illustrates the behavior of the other example of the seat, specifically illustrating a state at the leaving of the medium from the intermediate transfer belt;

FIG. 11A illustrates a behavior of one example of the seat in a case where an image receiving surface of the medium is inclined in a direction intersecting a direction of transport, specifically illustrating how the image receiving surface of the medium is inclined;

FIG. 11B illustrates the behavior of the one example of the seat, specifically illustrating a state where image transfer is in progress;

FIG. 12A illustrates a behavior of another example of the seat in the case where the image receiving surface of the medium is inclined in a direction intersecting the direction of transport, specifically illustrating how the image receiving surface of the medium is inclined;

FIG. 12B illustrates the behavior of the other example of the seat, specifically illustrating a state where image transfer is in progress;

FIG. 13A illustrates the position of the leading end of a transferring image on the intermediate transfer belt; and

FIG. 13B illustrates an image start position on the medium.

### DETAILED DESCRIPTION

An exemplary embodiment of the present disclosure will now be described in detail with reference to the accompanying drawings. An image forming apparatus according to the present exemplary embodiment is based on digital printing. While there are some digital printing schemes including an electrophotographic scheme and an inkjet scheme, the present exemplary embodiment assumes an electrophotographic scheme. In an electrophotographic scheme, when an image is transferred to a medium, a transfer unit and the medium come into contact with each other. The present exemplary embodiment further assumes that the object of printing is any of various media each having a certain hardness and a certain thickness, such as metal, glass, and a tile.

### Configuration of Apparatus

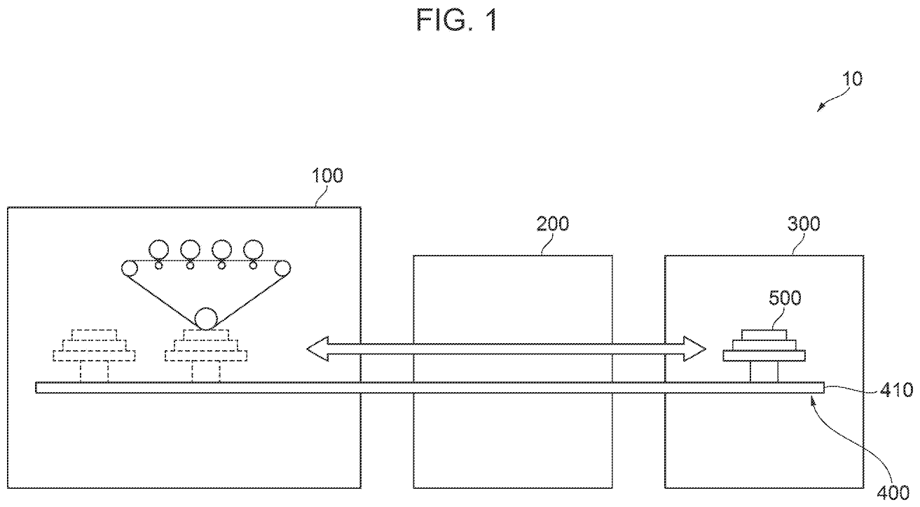

FIG. 1 illustrates a configuration of an image forming apparatus 10 to which the present exemplary embodiment is applied. The image forming apparatus 10 includes a transfer unit 100, a fixing unit 200, a medium mounting/dismounting unit 300, and a transporting mechanism 400. The image forming apparatus 10 further includes a controller (not illustrated) that includes the following: one or a plurality of processors serving as arithmetic units, a memory serving as a work area for data processing, and a storage device that stores programs and data. The controller may be a single controller configured to control the entirety of the image forming apparatus 10, or may be provided for each of the transfer unit 100, the fixing unit 200, the transporting mechanism 400, and other relevant elements.

The transfer unit 100 is configured to transfer an image composed of particles such as toner to a medium 500, which is the object of transfer. The fixing unit 200 is configured to heat the medium 500 having the image transferred to a surface thereof by the transfer unit 100 and thus fix the image. The medium mounting/dismounting unit 300 is provided for the user of the image forming apparatus 10 to mount the medium 500 on a mounting table 420 (to be described separately below), which is included in the transporting mechanism 400. The transporting mechanism 400 extends over the transfer unit 100, the fixing unit 200, and the medium mounting/dismounting unit 300 and is configured to transport the medium 500, which is the object of printing, among the units 100, 200, and 300 as represented by the arrow illustrated in FIG. 1.

The medium mounting/dismounting unit 300 includes a housing having an opening through which the medium 500 is to be inserted into and removed from the medium mounting/dismounting unit 300. The medium mounting/dismounting unit 300 houses an end portion of a transporting rail 410, which is included in the transporting mechanism 400. A transport start position and a transport end position are defined inside the medium mounting/dismounting unit 300. In the image forming apparatus 10 illustrated in FIG. 1, the transport start position and the transport end position coincide with each other. In the initial state, the mounting table 420 included in the transporting mechanism 400 is set at a position of the transporting rail 410 that is defined as the transport start position and the transport end position. The user inserts a medium 500 into the medium mounting/dismounting unit 300 through the opening of the housing and mounts the medium 500 onto the mounting table 420, whereby the medium 500 is ready to be transported by the transporting mechanism 400. The medium 500 mounted on the mounting table 420 may be fixed to the mounting table 420 by a jig or the like that is intended to hold the medium 500. After the transfer unit 100 transfers an image to the medium 500 and the fixing unit 200 fixes the image, the mounting table 420 carrying the medium 500 moves along the transporting rail 410 to the transport end position. In this state, the user dismount the medium 500 from the mounting table 420 and removes the medium 500 from the medium mounting/dismounting unit 300 through the opening of the housing.

### Configuration of Transfer Unit 100

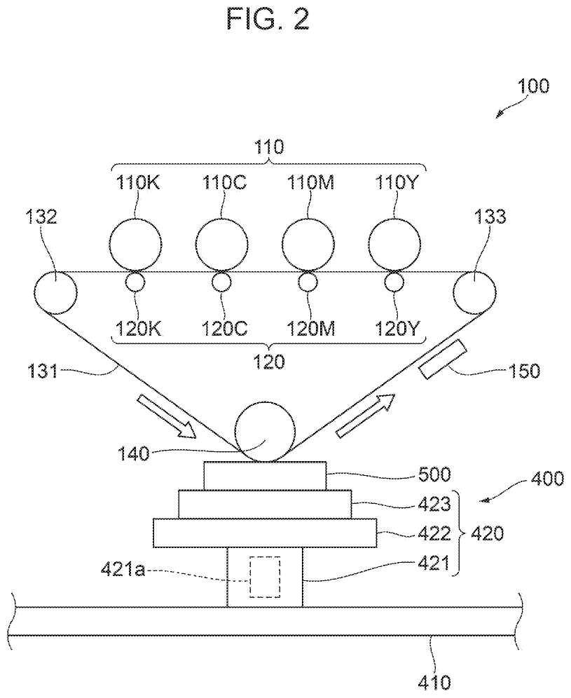

FIG. 2 illustrates a configuration of the transfer unit 100. The transfer unit 100 is configured to form an image from charged particles and generate an electric field, with which the image is transferred to a medium 500. The transfer unit 100 includes a developing device 110, a first-transfer roll 120, and an intermediate transfer belt 131. The intermediate transfer belt 131 is stretched over rollers 132 and 133 and a backup roll 140 in an area between the developing device 110 and a position where image transfer to the medium 500 is to be performed. The transfer unit 100 further includes a cleaning device 150, which is configured to remove particles adhered to the intermediate transfer belt 131.

The developing device 110 is configured to form on a photoconductor an electrostatic latent image for forming an image to be transferred and to bring charged particles into contact with the electrostatic latent image on the photoconductor, thereby developing the image. The developing device 110 may be a known device intended for electrophotographic image forming apparatuses. FIG. 2 illustrates an exemplary configuration for forming a color image composed of four colors: three colors of yellow, magenta, and cyan, with the addition of black. The developing device 110 is provided for each of the four colors of yellow, magenta, cyan, and black, which are represented by Y, M, C, and K and are given as suffixes to the reference numeral of the respective developing devices 110 in FIG. 2. In the following description, the developing devices 110 are denoted with the suffixes Y, M, C, and K if they are to be distinguished from one another by their colors, or without the suffixes Y, M, C, and K if not.

The first-transfer roll 120 is to be used in the transfer (first transfer) of the image formed by the developing device 110 to the intermediate transfer belt 131. The first-transfer roll 120 is positioned face to face with the photoconductor of the developing device 110, with the intermediate transfer belt 131 interposed between the developing device 110 and the first-transfer roll 120. The first-transfer roll 120 is provided for each of the developing devices 110Y, 110M, 110C, and 110K. In FIG. 2, the first-transfer rolls 120 provided for the developing devices 110Y, 110M, 110C, and 110K for the respective colors are denoted with suffixes Y, M, C, and K representing the respective colors. In the following description, the first-transfer rolls 120 are denoted with the suffixes Y, M, C, and K if they are to be distinguished from one another by their colors, or without the suffixes Y, M, C, and K if not.

The intermediate transfer belt 131, the rollers 132 and 133, and the backup roll 140 are to be used in the transfer of the images formed by the developing devices 110 to a medium 500. As illustrated in FIG. 2, the intermediate transfer belt 131 stretched over the rollers 132 and 133 and the backup roll 140 is to be rotated in the direction represented by the arrows in FIG. 2 (counterclockwise in the configuration illustrated in FIG. 2). At a “transfer position”, which will be described separately below, the direction of rotation of the intermediate transfer belt 131 coincides with the direction of transport of the medium 500 by the transporting mechanism 400. To rotate the intermediate transfer belt 131, for example, at least one of the rollers 132 and 133 is given a function of a driving roller configured to rotate in such a manner as to drag the intermediate transfer belt 131.

The intermediate transfer belt 131 is to carry an image by a surface thereof that is on the outer side in the configuration illustrated in FIG. 2 (the surface is hereinafter referred to as “transfer surface”). When the intermediate transfer belt 131 passes through the nip between each of the developing devices 110 and a corresponding one of the first-transfer rolls 120, an image is transferred from the photoconductor of the developing device 110 to the transfer surface of the intermediate transfer belt 131. In the exemplary configuration illustrated in FIG. 2, the developing devices 110Y, 110M, 110C, and 110K and the first-transfer rolls 120Y, 120M, 120C, and 120K cooperate to superpose images in the respective colors of yellow (Y), magenta (M), cyan (C), and black (K) one on top of another onto the transfer surface, whereby a multicolor image is formed.

The backup roll 140 is intended to bring the transfer surface of the intermediate transfer belt 131 into contact with the medium 500, whereby the transfer (second transfer) of the image to the medium 500 is achieved. The backup roll 140 is an exemplary transfer roller. In the process of image transfer, a predetermined voltage is applied to the backup roll 140. Accordingly, an electric field (hereinafter referred to as “transfer electric field”) is generated in an area spreading over the backup roll 140 and the medium 500 and causes the image, composed of charged particles, to be transferred from the intermediate transfer belt 131 to the medium 500. That is, to transfer an image from the intermediate transfer belt 131 to a medium 500, an electric current needs to flow from the backup roll 140 to the medium 500 through the intermediate transfer belt 131. If the medium 500 is a conductor such as metal, since the medium 500 itself allows the electric current to flow therethrough, the image is transferred to a surface of the medium 500 by simply generating a transfer electric field. If the medium 500 is not a conductor, since the medium 500 does not allow the electric current to flow therethrough, the image is not allowed to be transferred simply. If the medium 500 is not a conductor, at least an area of the surface of the medium 500 where an image is to be transferred is subjected to a preparatory treatment for allowing an electric current to flow through the medium 500: for example, a layer of a conductive material is formed over the above area.

Now, a procedure of image transfer by using the intermediate transfer belt 131 will be described. As the intermediate transfer belt 131 rotates, the developing devices 110Y, 110M, 110C, and 110K and the first-transfer rolls 120Y, 120M, 120C, and 120K cooperate to superpose images in the respective colors of yellow (Y), magenta (M), cyan (C), and black (K) one on top of another onto the transfer surface (the outer surface in FIG. 2) of the intermediate transfer belt 131, whereby a multicolor image is formed. As the intermediate transfer belt 131 further rotates, the image formed on the transfer surface of the intermediate transfer belt 131 reaches a position where the intermediate transfer belt 131 comes into contact with the medium 500 (the position is hereinafter referred to as “transfer position”). Then, as described above, a voltage is applied to the backup roll 140 to generate a transfer electric field, with which the image is transferred from the intermediate transfer belt 131 to the medium 500.

The cleaning device 150 is configured to remove particles adhered to the transfer surface of the intermediate transfer belt 131. The cleaning device 150 is located, in the direction of rotation of the intermediate transfer belt 131, downstream of the transfer position but upstream of the developing device 110Y and the first-transfer roll 120Y. Therefore, after the completion of image transfer from the intermediate transfer belt 131 to the medium 500, particles remaining on the transfer surface of the intermediate transfer belt 131 are removed by the cleaning device 150. Then, in the next operation cycle, the transfer (first transfer) of another image is performed on the transfer surface refreshed by the removal of particles.

### Configuration of Transporting Mechanism 400 and Structure for Mounting Medium 500

A structure on which the medium 500 is to be mounted will now be described. The present exemplary embodiment assumes that the medium 500 is any of various media having different thicknesses and shapes. In a configuration in which the medium 500 to be transported is directly mounted on a transport path that is formed of elements including a belt and rollers, since different media 500 having different thicknesses or shapes have different heights from the transport path at the transfer position in the transfer unit 100, it is difficult to appropriately bring the intermediate transfer belt 131 into contact with each of such media 500. Specifically, the intermediate transfer belt 131 may fail to come into contact with a medium 500 that is short in height, or may strongly impact upon a medium 500 that is tall in height. In view of the above, the transporting mechanism 400 according to the present exemplary embodiment includes the mounting table 420, which includes a height controller and is to be transported with the medium 500 mounted thereon.

Referring to FIG. 2, the transporting mechanism 400 includes the transporting rail 410, which defines the transport path for the medium 500; and the mounting table 420, which moves along the transporting rail 410. The mounting table 420 includes a leg 421, which is attached to the transporting rail 410; and a seat 422, on which the medium 500 is to be mounted. The seat 422 has a function of changing the inclination of the medium 500 while carrying the medium 500, in accordance with the state of contact between the medium 500 and the intermediate transfer belt 131. Details of this function will be described separately below. The seat 422 is provided with a jig 423, which is placed on the seat 422 and is intended to hold the medium 500. The transporting mechanism 400 is an exemplary transporting unit.

In the exemplary configuration illustrated in FIG. 1, the transporting rail 410 extends from the medium mounting/dismounting unit 300 through the fixing unit 200 to the transfer unit 100. The end of the transporting rail 410 that is located in the medium mounting/dismounting unit 300 is regarded as the transport start position and the transport end position. The mounting table 420 is transported from the transport start position in the medium mounting/dismounting unit 300 toward the left side in FIG. 1 to the transfer unit 100, where an image is transferred to the medium 500. After the image is transferred, the mounting table 420 is transported toward the right side in FIG. 1 to the fixing unit 200, where the image on the medium 500 is fixed. Then, the mounting table 420 is transported to the transport end position in the medium mounting/dismounting unit 300.

The leg 421 is attached to the transporting rail 410 and is movable along the transporting rail 410. The leg 421 is an exemplary movable member. A mechanism of moving the leg 421 along the transporting rail 410 is not particularly limited. For example, the leg 421 may include a driving device so as to be movable by itself, or the transporting rail 410 may be provided with a towing device configured to tow the leg 421.

The leg 421 includes a lift 421a, which serves as a height controller configured to control the height level of the seat 422. In the process of image transfer to a medium 500 by using the intermediate transfer belt 131, the lift 421a adjusts the height of the mounting table 420 such that a leading part of the medium 500 in the direction of transport comes into contact with the intermediate transfer belt 131 at a position of the transport path that is on the upstream side in the direction of transport relative to a position where any other part of the medium 500 comes into contact with the intermediate transfer belt 131. Note that the leading part of the medium 500 in the direction of transport refers to the point of first contact of the medium 500 with the intermediate transfer belt 131. How the lift 421a controls the height of the mounting table 420 will be described separately below.

The configuration of the lift 421a is not particularly limited. For example, the seat 422 may be raised and lowered by using a rack-and-pinion device and a driving motor. Alternatively, the height level of the seat 422 may be controlled by manually operating a gear that moves in accordance with the change in the height level of the seat 422. Such an operation of height control may be implemented in any of various ways. For example, an interface for input to a controller that controls the driving motor may be prepared so that the operator of the image forming apparatus 10 is allowed to manually input height data through the interface. Alternatively, a sensor may be used to automatically detect the height of the medium 500 mounted on the mounting table 420, and the driving motor may be controlled to align the medium 500 at an appropriate height level.

The seat 422 is attached to the leg 421 and receives the medium 500 mounted thereon with the jig 423 interposed therebetween. The seat 422 is provided with a fastener (not illustrated) intended to position the jig 423. Any jig 423 that fits the fastener is positionable on and attachable to the seat 422, regardless of the shape of the jig 423 itself.

The seat 422 is movable up and down relative to the leg 421 in accordance with the pressure applied thereto from above. Thus, the medium 500 is brought into contact with the intermediate transfer belt 131 with a pressure that is appropriate for image transfer at the transfer position. Furthermore, as described above, the seat 422 is configured to change the inclination of the medium 500 in accordance with the state of contact between the medium 500 and the intermediate transfer belt 131.

The jig 423 is attached to the seat 422 while holding the medium 500. A portion of the jig 423 where the jig 423 is attached to the seat 422 has a shape or structure that fits the fastener provided to the seat 422. Furthermore, the jig 423 is shaped to be able to hold the medium 500. Therefore, if a jig 423 that fits various media 500 having different shapes and sizes is prepared, any of such media 500 having different shapes and sizes are mountable on the mounting table 420.

### Configuration of Fixing Unit 200

After an image is transferred to a medium 500 in the transfer unit 100, the image is fixed in the fixing unit 200. In the present exemplary embodiment, since images are to be formed on various media 500 having different thicknesses and shapes, fixing is performed by, for example, a device employing a noncontact scheme. The fixing unit 200 is configured to heat and melt the particles composing the image transferred to the medium 500, thereby fixing the image on the surface of the medium 500.

The fixing unit 200 includes a heat source for thermal fixing. The heat source may be any of various known heat sources, such as a halogen lamp, a ceramic heater, and an infrared lamp. The heat source may be replaced with a device that emits infrared laser light to heat the particles composing the image. The fixing unit 200 may include a covering to be placed over the heat source, and the heat source may be exposed when fixing is performed. The covering may be, for example, a shutter or a door. Alternatively, a heat-insulating curtain or an air curtain may be provided to prevent the leakage of air from the inside of the fixing unit 200.

### Preparatory Operation for Image Formation

The image forming apparatus 10 according to the present exemplary embodiment includes the transporting mechanism 400 configured as above and is therefore capable of performing printing on various media 500 having different shapes and sizes. However, before the operation of image transfer is started, an operation of controlling the height level of the seat 422 is to be performed to prevent the occurrence of a strong impact at the contact of the medium 500 with the intermediate transfer belt 131 of the transfer unit 100 or the failure in bringing the medium 500 into contact with the intermediate transfer belt 131 in the process of image transfer to the medium 500.

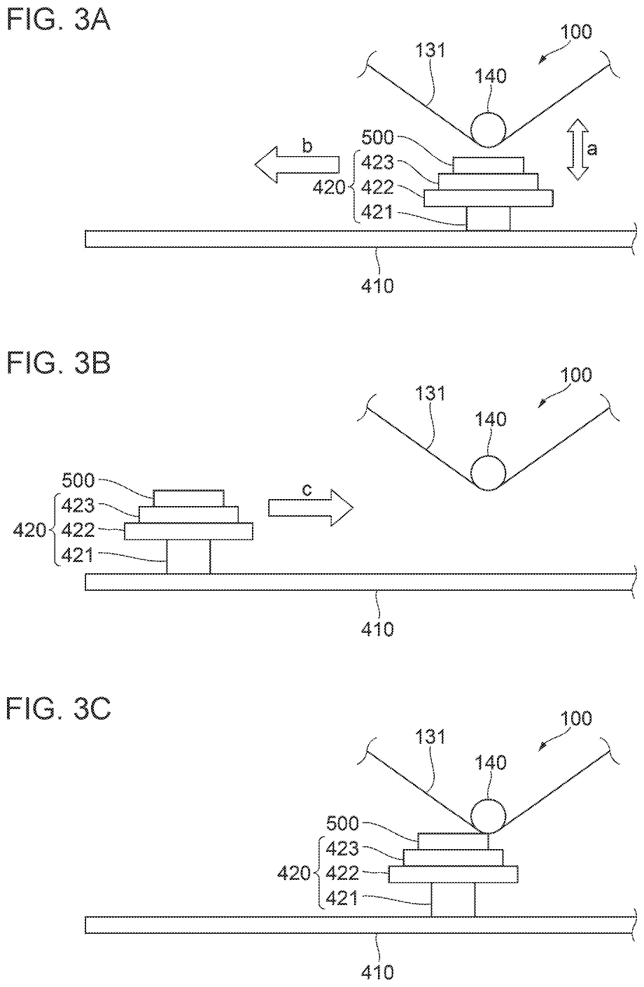

FIGS. 3A to 3C illustrate a behavior of the transporting mechanism 400 before the transfer unit 100 starts image transfer. Specifically, FIG. 3A illustrates a state where height control is underway, FIG. 3B illustrates a state where the transporting mechanism 400 is retracted to a standby position after height control, and FIG. 3C illustrates a state where the transfer unit 100 starts image transfer.

Image formation on a medium 500 is performed as follows. First, a medium 500 held by the jig 423 is mounted on the mounting table 420 at the transport start position in the medium mounting/dismounting unit 300. Then, after the medium 500 is lowered by the lift 421a included in the mounting table 420 to such a height level as not to come into contact with the intermediate transfer belt 131 provided in the transfer unit 100, the mounting table 420 carrying the medium 500 is moved to a position below the transfer position defined in the transfer unit 100.

At the transfer position, height control for the mounting table 420 is performed such that the medium 500 comes into contact with the intermediate transfer belt 131 with a pressure that is appropriate for image transfer (as represented by arrow a in FIG. 3A). When the operation of height control is complete, information on the height level determined to be appropriate (the height level is hereinafter referred to as “transfer-execution height”) is stored in a memory included in the controller or the like. Then, the mounting table 420 is lowered such that the medium 500 goes out of contact with the intermediate transfer belt 131, and the mounting table 420 is moved toward the standby position (as represented by arrow b in FIG. 3A) to be prepared for the operation of transfer. Note that the transfer-execution height, to be described in detail separately below, is defined at a level slightly higher than a part of the intermediate transfer belt 131 that is located at the transfer position.

When the mounting table 420 reaches the standby position, the height of the mounting table 420 is adjusted such that the medium 500 is aligned at the transfer-execution height, on the basis of the information acquired in the operation of height control. Subsequently, the mounting table 420 is moved toward the transfer position (as represented by arrow c in FIG. 3B) to bring the medium 500 into contact with the intermediate transfer belt 131 at the transfer position, where image transfer is started (see FIG. 3C).

### Height Control for Mounting Table 420 by Lift 421a

The operation of height control for the mounting table 420 by using the lift 421a will further be described. As described above, the transfer-execution height is determined in the preparatory operation. More specifically, the transfer-execution height is determined such that the leading part of the medium 500 in the direction of transport comes into contact with the intermediate transfer belt 131 at a position of the transport path that is on the upstream side in the direction of transport relative to a position where any other part of the medium 500 comes into contact with the intermediate transfer belt 131. In other words, the transfer-execution height is determined such that the leading part of the medium 500 in the direction of transport comes into contact with the intermediate transfer belt 131 at a level higher than the level of the transfer position in the direction of movement of the intermediate transfer belt 131.

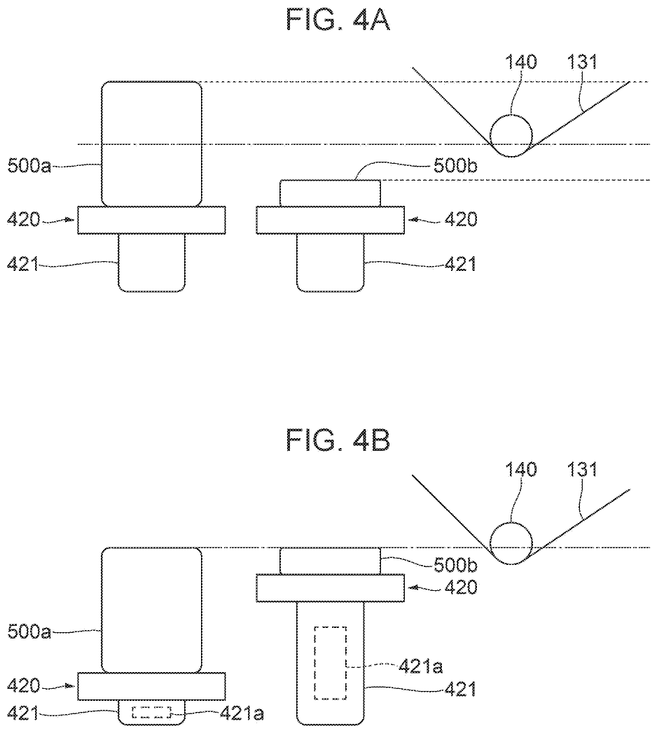

FIGS. 4A and 4B illustrate an exemplary operation of height control for the mounting table 420 by using the lift 421a. Specifically, FIG. 4A illustrates media 500 having different heights, and FIG. 4B illustrates the media 500 each aligned at the transfer-execution height by using the lift 421a. In FIGS. 4A and 4B, the transfer-execution height is represented by a one-dot chain line. In FIGS. 4A and 4B, the thicker one of the media 500 is denoted by 500a, and the thinner one of the media 500 is denoted by 500b.

As illustrated in FIG. 4A, when media 500 having different thicknesses are to be handled, the surfaces of the media 500 that are to receive images (the surfaces are each hereinafter referred to as “image receiving surface”) are staggered relative to the transfer-execution height. In FIG. 4A, the upper surface, serving as the image receiving surface, of the thick medium 500a is located above the transfer-execution height, whereas the upper surface, serving as the image receiving surface, of the thin medium 500b is located below the transfer-execution height.

In the present exemplary embodiment, as illustrated in FIG. 4B, the lift 421a controls the height of the mounting table 420 in accordance with the thickness of the medium 500 of interest such that the image receiving surface of the medium 500 is aligned at the transfer-execution height. In FIG. 4B, the image receiving surface of each of the thick medium 500a and the thin medium 500b is aligned at the transfer-execution height.

### Position of Contact between Medium 500 and Intermediate Transfer Belt 131

The position of contact between the medium 500 and the intermediate transfer belt 131 will now be described. As described above, the transfer-execution height is at a level slightly higher than a part of the intermediate transfer belt 131 that is located at the transfer position. Accordingly, the position of first contact between the medium 500 and the intermediate transfer belt 131 (the position is hereinafter referred to as “first contact position”) is higher than the transfer position. The first contact position is located upstream of the transfer position in the direction of transport. Therefore, in the process of image transfer to the medium 500, the leading part of the medium 500 first reaches the first contact position located upstream of the transfer position and then advances to the transfer position together with the intermediate transfer belt 131 that is rotating. As the medium 500 further advances together with the rotating intermediate transfer belt 131, the remaining part of the medium 500 other than the leading part sequentially comes into contact with the intermediate transfer belt 131 at the transfer position. Note that the first contact position is at the same level as the transfer-execution height.

Since the medium 500 first comes into contact with the intermediate transfer belt 131 at the first contact position, the intermediate transfer belt 131 receives a great load at the first contact position. If the intermediate transfer belt 131 is bent under the load, the image on the transfer surface may be deteriorated. Hence, the first contact position is defined such that the intermediate transfer belt 131 is less likely to be affected by the load generated at the contact of the medium 500 with the intermediate transfer belt 131.

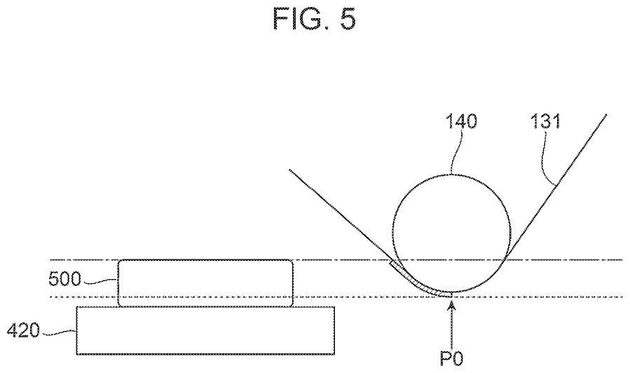

FIG. 5 illustrates an example of the first contact position. In the example illustrated in FIG. 5, the first contact position is defined in an area upstream of the transfer position, P0, and where the intermediate transfer belt 131 runs along the backup roll 140 (the area where the intermediate transfer belt 131 is boldly highlighted in FIG. 5). In the area where the intermediate transfer belt 131 runs along the backup roll 140, the backup roll 140 supports the intermediate transfer belt 131 when the medium 500 comes into contact with the intermediate transfer belt 131.

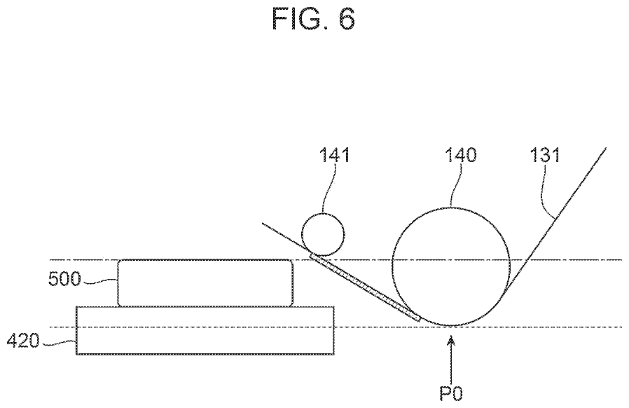

FIG. 6 illustrates another example of the first contact position. In the example illustrated in FIG. 6, a preceding roll 141 is provided near and upstream of the backup roll 140 in the direction of rotation of the intermediate transfer belt 131. The first contact position is defined in an area between the preceding roll 141 and the backup roll 140 (the area where the intermediate transfer belt 131 is boldly highlighted in FIG. 6). The tension of the intermediate transfer belt 131 in the area between the preceding roll 141 and the backup roll 140 becomes greater as the distance between the preceding roll 141 and the backup roll 140 becomes shorter. As the tension of the intermediate transfer belt 131 in the area between the preceding roll 141 and the backup roll 140 becomes greater, the resistance of the intermediate transfer belt 131 against the load applied thereto becomes greater. Hence, the distance between the preceding roll 141 and the backup roll 140 is set such that the tension of the intermediate transfer belt 131 in the area between the preceding roll 141 and the backup roll 140 is greater than or equal to a predetermined value. The value of the tension is determined in view of the load supposed to be generated when the medium 500 comes into contact with the intermediate transfer belt 131.

### Configuration of Mounting Table 420

The configuration of the mounting table 420 will further be described in detail. In the image forming apparatus 10 according to the present exemplary embodiment, as described above referring to FIG. 2, an image formed on the intermediate transfer belt 131 in the transfer unit 100 is transferred to a medium 500 by bringing the intermediate transfer belt 131 into contact with the medium 500. Furthermore, the seat 422 is movable up and down relative to the leg 421 of the mounting table 420, so that the inclination of the medium 500 coming into contact with the intermediate transfer belt 131 is changeable. In other words, the seat 422 changes the height level thereof while inclining in accordance with the state of contact between the medium 500 and the intermediate transfer belt 131. Such a mechanism of changing the height level and inclination of the seat 422 will now be described in detail.

Possible options for the mechanism of changing the height level of the seat 422 include a passive mechanism and an active mechanism. In the passive mechanism, the height level of the seat 422 is changed in accordance with the force of contact of the medium 500 with the intermediate transfer belt 131, whereby the inclination of the medium 500 is changed. In the active mechanism, the height level of the seat 422 is changed in such a manner as to reduce the change in the force of contact between the medium 500 and the intermediate transfer belt 131, whereby the inclination of the medium 500 is changed. The two mechanisms will now be described individually.

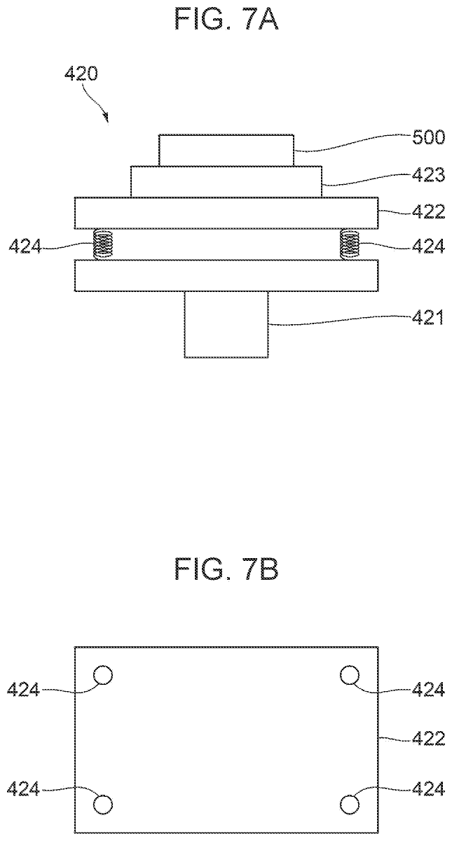

FIG. 7A is a side view of the passive mechanism, illustrating an exemplary configuration of the seat 422, and FIG. 7B is a bottom view of the passive mechanism, illustrating the exemplary configuration of the seat 422. In the passive mechanism, the seat 422 includes a body, on which the medium 500 held by the jig 423 is to be mounted; and an clastic member 424, which is provided on the back face of the body that is opposite the face on which the medium 500 is to be mounted. In other words, the seat 422 is supported by the elastic member 424 at the top face of the leg 421. In the example illustrated in FIGS. 7A and 7B, the clastic member 424 is a spring provided at each of a plurality of positions on the back face of the body that is opposite the face on which the medium 500 is to be mounted. Hereinafter, the springs each serving as the elastic member are also denoted by 424. In the example illustrated in FIG. 7B, the body has a rectangular shape, and a total of four springs 424 are provided at the four respective corners of the bottom face of the body.

When the mounting table 420 receives a pressure from above, the springs 424 are compressed by the pressure received, whereby the seat 422 is lowered. When the pressure applied to the mounting table 420 from above is reduced, the seat 422 is pushed upward by the repulsive force of the springs 424. The plurality of springs 424 are independent of each other and individually support the seat 422. Therefore, the seat 422 is not simply lowered but also inclines in accordance with the position where the pressure is applied.

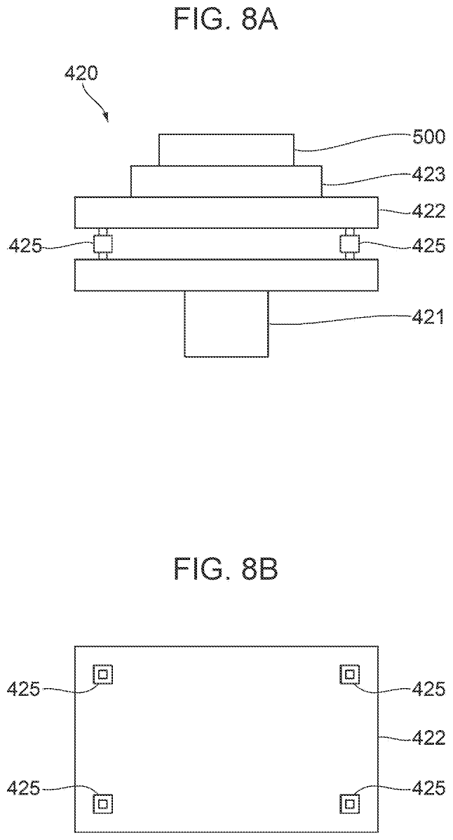

FIG. 8A is a side view of the active mechanism, illustrating an exemplary configuration of the seat 422, and FIG. 8B is a bottom view of the active mechanism, illustrating the exemplary configuration of the seat 422. In the active mechanism, the seat 422 includes a body, on which the medium 500 held by the jig 423 is to be mounted; and a support 425, which is provided on the back face of the body that is opposite the face on which the medium 500 is to be mounted. In other words, the seat 422 is supported by the support 425 at the top face of the leg 421. In the example illustrated in FIGS. 8A and 8B, the support 425 is a pin provided at each of a plurality of positions on the back face of the body that is opposite the face on which the medium 500 is to be mounted. In the example illustrated in FIG. 8B, the body has a rectangular shape, and a total of four supports 425 are provided at the four respective corners of the bottom face of the body.

The supports 425 each include a height changing mechanism and are capable of individually changing the heights thereof. The configuration of the height changing mechanism included in each of the supports 425 is not particularly limited. For example, the body of the seat 422 may be raised and lowered by using a rack-and-pinion device and a driving motor. The supports 425 are configured to individually change the heights thereof in accordance with, for example, a predetermined setting. Therefore, when the mounting table 420 is transported and the medium 500 comes into contact with the intermediate transfer belt 131, the seat 422 is not simply lowered but also inclines.

Alternatively, the supports 425 may include respective sensors that detect the pressure applied from above. In that case, if any increase in the pressure applied from above is detected, the supports 425 individually reduce their heights in accordance with the information detected by the respective sensors and in such a manner as to reduce the increase in the pressure applied. In contrast, if any reduction in the pressure applied from above is detected, the supports 425 individually increase their heights in such a manner as to lessen the reduction in the pressure applied. In such a mechanism as well, when the mounting table 420 is transported and the medium 500 comes into contact with the intermediate transfer belt 131, the seat 422 is not simply lowered but also inclines.

### Behavior of Seat 422

How the seat 422 of the mounting table 420 behaves in the process of image transfer to a medium 500 will now be described. As described above referring to FIGS. 5 and 6, the first contact position is at the same level as the transfer-execution height and is higher than the transfer position. Therefore, when the leading part of the medium 500 carried by the mounting table 420 comes into contact with the intermediate transfer belt 131 at the first contact position, the medium 500 is pushed downward by the intermediate transfer belt 131, whereby the seat 422 is lowered. Then, as the medium 500 advances beyond the transfer position, the seat 422 is raised, whereby the medium 500 is brought back to the transfer-execution height.

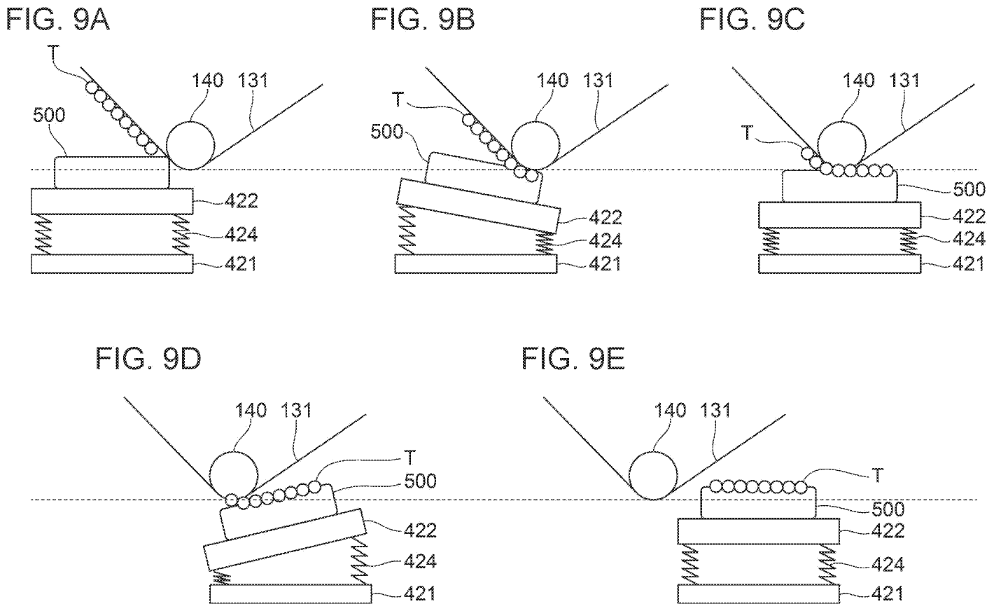

FIGS. 9A to 9E illustrate a behavior of one example of the seat 422 in the operation of transfer. Specifically, FIG. 9A illustrates a state at the contact of a medium 500 with the intermediate transfer belt 131, FIG. 9B illustrates a state at the start of transfer, FIG. 9C illustrates a state where transfer is in progress, FIG. 9D illustrates a state at the end of transfer, and FIG. 9E illustrates a state at the leaving of the medium 500 from the intermediate transfer belt 131. The mounting table 420 illustrated in FIGS. 9A to 9E is the one illustrated in FIGS. 7A and 7B in which the seat 422 is supported by the springs 424. In the example illustrated in FIGS. 9A to 9E, an image (toner image) T is transferred to a medium 500 while the mounting table 420 carrying the medium 500 moves from left to right in the drawings. Note that the illustration of the jig 423 is omitted in FIGS. 9A to 9E.

When the mounting table 420 carrying a medium 500 is transported for the transfer of an image T, as illustrated in FIG. 9A, the leading part of the medium 500 first comes into contact with the intermediate transfer belt 131 at the first contact position. As the medium 500 is further transported, the leading part of the medium 500 is guided toward the transfer position, which is located at a lower level than the first contact position. Hence, among the springs 424 supporting the seat 422, those springs 424 located on the leading side in the direction of transport are compressed. Accordingly, as illustrated in FIG. 9B, the leading side of the seat 422 in the direction of transport is lowered, and the seat 422 and the medium 500 incline in such a manner as to face forward in the direction of transport. In this state, the image T thus reached the transfer position starts to be transferred to the medium 500.

As the transport of the medium 500 and the transfer of the image T to the medium 500 progress, the position of contact of the medium 500 with the intermediate transfer belt 131 moves backward on the medium 500 in the direction of transport. Hence, those springs 424 located on the trailing side of the seat 422 in the direction of transport are gradually compressed, whereby, as illustrated in FIG. 9C, the entirety of the seat 422 of the mounting table 420 is lowered. As the transport of the medium 500 and the transfer of the image T to the medium 500 further progress and the position of contact of the medium 500 with the intermediate transfer belt 131 moves toward the trailing end of the medium 500, the pressure applied to compress those springs 424 located on the leading side of the seat 422 in the direction of transport is removed. Accordingly, as illustrated in FIG. 9D, the leading side of the seat 422 in the direction of transport is raised, whereby the seat 422 and the medium 500 incline in such a manner as to face backward in the direction of transport.

As the transport of the medium 500 further progresses and the transfer of the image T to the medium 500 is complete, the medium 500 leaves the intermediate transfer belt 131, whereby the pressure applied to compress those springs 424 located on the trailing side of the seat 422 in the direction of transport is also removed. Consequently, as illustrated in FIG. 9E, the entirety of the seat 422 is raised, whereby the medium 500 is brought back to the transfer-execution height.

To summarize, the height level of the seat 422 of the mounting table 420 is changed while the seat 422 is caused to incline in accordance with the force applied thereto at the contact between the transfer unit 100 and the medium 500.

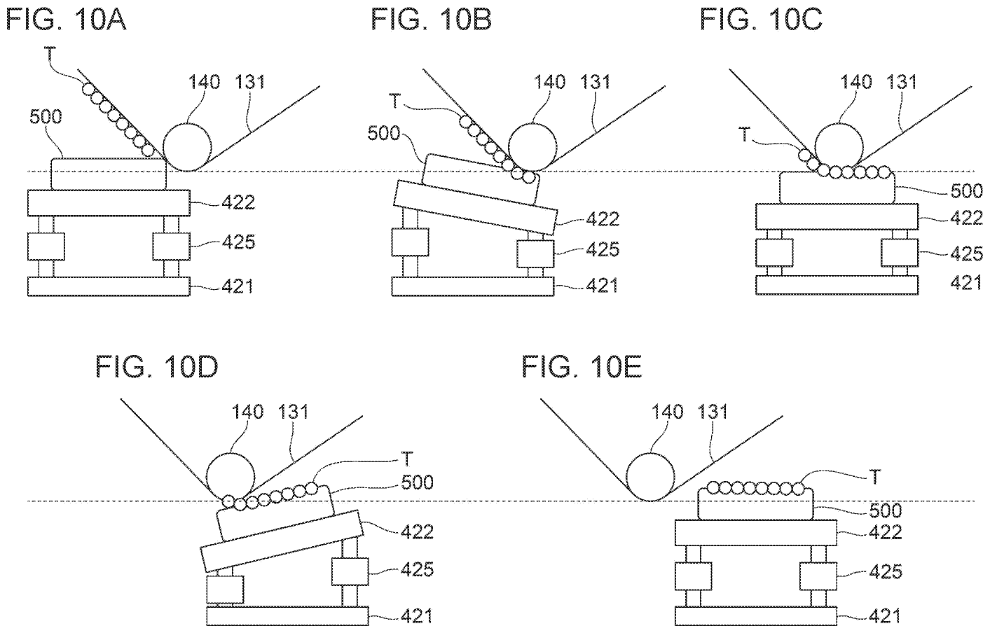

FIGS. 10A to 10E illustrate a behavior of another example of the seat 422 in the operation of transfer. Specifically, FIG. 10A illustrates a state at the contact of a medium 500 with the intermediate transfer belt 131, FIG. 10B illustrates a state at the start of transfer, FIG.

10C illustrates a state where transfer is in progress, FIG. 10D illustrates a state at the end of transfer, and FIG. 10E illustrates a state at the leaving of the medium 500 from the intermediate transfer belt 131. The mounting table 420 illustrated in FIGS. 10A to 10E is the one illustrated in FIGS. 8A and 8B in which the seat 422 is supported by the supports 425. In the example illustrated in FIGS. 10A to 10E, an image (toner image) T is transferred to a medium 500 while the mounting table 420 carrying the medium 500 moves from left to right in the drawings. Note that the illustration of the jig 423 is omitted in FIGS. 10A to 10E.

When the mounting table 420 carrying a medium 500 is transported for the transfer of an image T, as illustrated in FIG. 10A, the leading part of the medium 500 first comes into contact with the intermediate transfer belt 131 at the first contact position. As the medium 500 is further transported, the leading part of the medium 500 is guided toward the transfer position. Since the transfer position is at a lower level than the first contact position, among the supports 425 supporting the seat 422, those supports 425 located on the leading side in the direction of transport contract, whereby the leading side of the seat 422 in the direction of transport is lowered. Accordingly, as illustrated in FIG. 10B, the seat 422 and the medium 500 incline in such a manner as to face forward in the direction of transport. In this state, the image T thus reached the transfer position starts to be transferred to the medium 500.

As the transport of the medium 500 and the transfer of the image T to the medium 500 progress, the position of contact of the medium 500 with the intermediate transfer belt 131 moves backward on the medium 500 in the direction of transport. Then, to align the medium 500 at the height level of the transfer position, those supports 425 located on the trailing side of the seat 422 in the direction of transport gradually contract as illustrated in FIG. 10C, whereby the entirety of the seat 422 of the mounting table 420 is lowered. As the transport of the medium 500 and the transfer of the image T to the medium 500 further progress and the position of contact of the medium 500 with the intermediate transfer belt 131 moves toward the trailing end of the medium 500, those supports 425 located on the leading side of the seat 422 in the direction of transport expand. Accordingly, as illustrated in FIG. 10D, the leading side of the seat 422 in the direction of transport is raised by corresponding ones of the supports 425, whereby the seat 422 and the medium 500 incline in such a manner as to face backward in the direction of transport.

As the transport of the medium 500 further progresses and the transfer of the image T to the medium 500 is complete, the medium 500 leaves the intermediate transfer belt 131, whereby those supports 425 located on the trailing side of the seat 422 in the direction of transport also expand. Consequently, as illustrated in FIG. 10E, the entirety of the seat 422 is raised by the supports 425, whereby the medium 500 is brought back to the transfer-execution height.

To summarize, the supports 425 change the height level of the seat 422 of the mounting table 420 while inclining the seat 422 in such a manner as to reduce the change in the force applied thereto at the contact between the transfer unit 100 and the medium 500.

### Modified Behavior of Seat 422

The present exemplary embodiment is also applicable to a medium 500 whose thickness varies with the position thereof and whose image receiving surface is therefore inclined relative to the surface of the intermediate transfer belt 131 at the transfer position. A case to be discussed first is a medium 500 whose thickness varies in the direction of transport and whose image receiving surface is inclined correspondingly. In such a case, while the medium 500 is transported as described above referring to FIGS. 9A to 9E or FIGS. 10A to 10E. the seat 422 is moved up and down by the function of the springs 424 or the supports 425 in accordance with the change in the thickness of the medium 500.

A case to be discussed next is a medium 500 whose thickness varies in a direction intersecting the direction of transport and whose image receiving surface is inclined correspondingly. In such a case, the plurality of springs 424 or supports 425 individually expand and contract, thereby moving the seat 422 up and down in accordance with the inclination of the image receiving surface of the medium 500 in various directions. Now, the behavior of the seat 422 in the case of the medium 500 whose thickness varies in a direction intersecting the direction of transport will further be described with reference to relevant drawings.

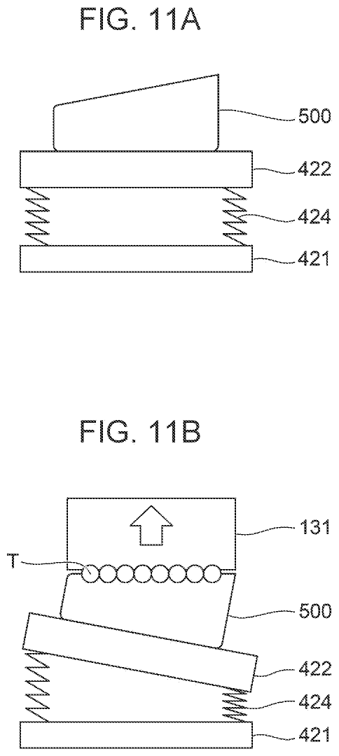

FIGS. 11A and 11B illustrate a behavior of one example of the seat 422 in the case where the image receiving surface of the medium 500 is inclined in a direction intersecting the direction of transport. Specifically, FIG. 11A illustrates how the image receiving surface of the medium 500 is inclined, and FIG. 11B illustrates a state where image transfer is in progress. The mounting table 420 illustrated in FIGS. 11A and 11B is the one illustrated in FIGS. 7A and 7B in which the seat 422 is supported by the springs 424. The medium 500 illustrated in FIGS. 11A and 11B are each viewed in the direction of transport. For simplicity, the case illustrated in FIGS. 11A and 11B assumes that the image receiving surface of the medium 500 is inclined linearly in a direction perpendicular to the direction of transport. Note that the illustration of the jig 423 is omitted in FIGS. 11A and 11B.

The medium 500 illustrated in FIG. 11A is thicker on the right side than on the left side as viewed from the leading side in the direction of transport. Correspondingly, the image receiving surface of the medium 500 is inclined to be higher on the right side and lower on the left side as viewed from the leading side in the direction of transport. Hence, when the image receiving surface of the medium 500 that is being transported reaches the transfer position, the image receiving surface is pushed downward by the intermediate transfer belt 131 with a greater force on the right side than on the left side as viewed from the leading side in the direction of transport. Accordingly, among the springs 424 supporting the seat 422, those springs 424 located on the right side as viewed from the leading side in the direction of transport are compressed more strongly than those springs 424 located on the left side. Since the seat 422 is thus lowered more greatly on the right side than on the left side as viewed from the leading side in the direction of transport, as illustrated in FIG. 11B, the image receiving surface of the medium 500 comes to extend parallel to the intermediate transfer belt 131 at the transfer position, whereby the transfer of the image T to the medium 500 is successfully performed.

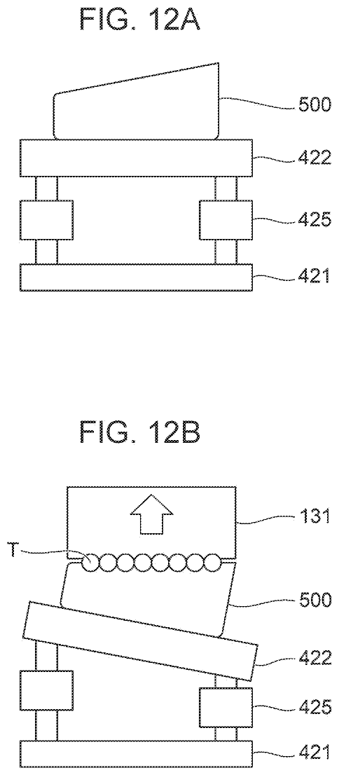

FIGS. 12A and 12B illustrate a behavior of another example of the seat 422 in the case where the image receiving surface of the medium 500 is inclined in a direction intersecting the direction of transport. Specifically, FIG. 12A illustrates how the image receiving surface of the medium 500 is inclined, and FIG. 12B illustrates a state where image transfer is in progress. The mounting table 420 illustrated in FIGS. 12A and 12B is the one illustrated in FIGS. 8A and 8B in which the seat 422 is supported by the supports 425. The medium 500 illustrated in FIGS. 12A and 12B are each viewed in the direction of transport. For simplicity, the case illustrated in FIGS. 12A and 12B assumes that the image receiving surface of the medium 500 is inclined linearly in a direction perpendicular to the direction of transport. Note that the illustration of the jig 423 is omitted in FIGS. 12A and 12B.

The medium 500 illustrated in FIG. 12A is thicker on the right side than on the left side as viewed from the leading side in the direction of transport. Correspondingly, the image receiving surface of the medium 500 is inclined to be higher on the right side and lower on the left side as viewed from the leading side in the direction of transport. Hence, when the image receiving surface of the medium 500 that is being transported reaches the transfer position, those of the supports 425 supporting the seat 422 that are located on the right side as viewed from the leading side in the direction of transport are caused to contract more greatly than those supports 425 located on the left side. Accordingly, the seat 422 is lowered more greatly on the right side than on the left side as viewed from the leading side in the direction of transport. Thus, as illustrated in FIG. 12B, the image receiving surface of the medium 500 comes to extend parallel to the intermediate transfer belt 131 at the transfer position, whereby the transfer of the image T to the medium 500 is successfully performed.

In the above case, since the medium 500 is thicker on the right side than on the left side as viewed from the leading side in the direction of transport, the supports 425 located on the right side are caused to contract more greatly than the supports 425 located on the left side. If the medium 500 viewed from the leading side in the direction of transport is extremely thin on the left side, the supports 425 located on the left side may be caused to expand to raise the medium 500 such that the image receiving surface of the medium 500 comes to extend parallel to the intermediate transfer belt 131 at the transfer position.

### How to Control Position of Image on Transfer Surface and Position of Image Receiving Surface

How to control the position of the image on the transfer surface of the intermediate transfer belt 131 and the position of the image receiving surface of the medium 500 will now be described. In the process of image transfer to a medium 500 in the present exemplary embodiment, the medium 500 is bought into contact with the intermediate transfer belt 131 at the first contact position defined upstream of the transfer position, and the medium 500 is further transported therefrom such that the image receiving surface is guided toward the transfer position. Therefore, the time when the position of the image receiving surface from which the image starts to be formed (hereinafter referred to as “image start position”) reaches the transfer position needs to coincide with the time when the leading end of the image carried by the intermediate transfer belt 131 (hereinafter referred to as “transferring image”) reaches the transfer position.

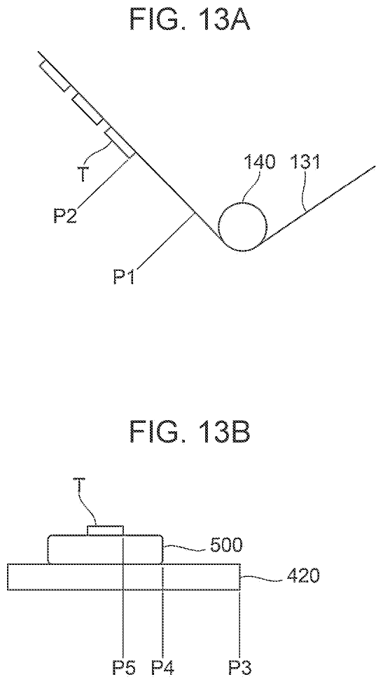

FIG. 13A illustrates the position of the leading end of the transferring image on the intermediate transfer belt 131, and FIG. 13B illustrates the image start position on the medium 500. Note that FIGS. 13A and 13B each independently illustrate a corresponding one of the positions defined on the intermediate transfer belt 131 and the medium 500, and the sizes of the intermediate transfer belt 131 and other elements illustrated in FIG. 13A do not match the sizes of the medium 500 and other elements illustrated in FIG. 13B. Furthermore, the illustration of the jig 423 is omitted in FIGS. 13A and 13B.

An area of the transfer surface of the intermediate transfer belt 131 that is to meet the image receiving surface of the medium 500 at the transfer position, in other words, an area of the transfer surface where the image to be transferred to the medium 500 is allowed to be carried, is regarded as an imaging area. Referring to FIG. 13A, the position of the leading end of the imaging area in the direction of rotation of the intermediate transfer belt 131 is denoted by P1. Furthermore, in the imaging area, the position of the leading end of the transferring image to be transferred to the medium 500 is denoted by P2. The relationship between the position P1 and the position P2 is determined by the specifications of the image forming apparatus 10. Therefore, information on the relationship between the positions P1 and P2 is stored in advance in a storage device such as a read-only memory (ROM), or is acquired from an external server or the like through network communication.

On the other hand, the position of the leading end of the mounting table 420, carrying the medium 500, in the direction of transport is denoted by P3. Furthermore, the position of the leading end of the medium 500 in the direction of transport is denoted by P4. Note that the position of the leading end of the medium 500 in the direction of transport coincides with the position of the leading end of the image receiving surface of the medium 500 in the direction of transport. The image start position on the image receiving surface is denoted by P5.

The relationship between the position P3 and the position P4 may be identified by, for example, using an optical sensor provided on the transport path. Specifically, an optical sensor may be provided on the transport path so that the distance between the position P3 of the mounting table 420 and the position P4 of the medium 500 is identifiable from the timings of interruption of light, emitted from the optical sensor, at the position P3 and the position P4 and from the speed of transport. In such a case, information on the relationship between the positions P3 and P4 is acquired through an analysis of detection signals generated by the optical sensor and information on the operation of controlling the transporting mechanism 400 (see FIGS. 1 and 2).

Alternatively, the position P3 of the mounting table 420 and the position P4 of the medium 500 may be identified from the structure of the jig 423 that is set on the mounting table 420 with the medium 500 held thereto. In such a case, the relationship between the position P3 and the position P4 is determined by the specifications of the mounting table 420 and the jig 423. Therefore, information on the relationship between the positions P3 and P4 is stored in advance in a storage device such as a read-only memory (ROM), or is acquired from an external server or the like through network communication.

The relationship between the position P4 and the position P5 depends on what kind of an image is formed on the image receiving surface of the medium 500. Therefore, the information on the relationship is acquired by the user inputting relevant instructions regarding the data of the image to be formed on the medium 500 or settings for the formation of the image.

The above pieces of information are used in controlling the operation of image formation such that the position P2 and the position P5 meet each other. Specifically, for example, the timing of starting the transport of the medium 500 is controlled as follows. In the transporting mechanism 400, the medium 500 starts to be transported such that the position P2 of the image carried by the intermediate transfer belt 131 and the position P5 on the medium 500 transported by the transporting mechanism 400 simultaneously reach the transfer position.

As another example, the position on the transfer surface of the intermediate transfer belt 131 from which the developing device 110 (see FIG. 2) starts to form an image may be controlled. In such a method, the controller of the image forming apparatus causes the developing device 110 to start forming an image from a position on the transfer surface of the intermediate transfer belt 131 that is supposed to reach the transfer position simultaneously with the position P5 on the medium 500 transported by the transporting mechanism 400.

While an exemplary embodiment of the present disclosure has been described above, the technical scope of the present disclosure is not limited to the above exemplary embodiment. For example, while the above exemplary embodiment relates to a case where the spring 424 or support 425 configured to move the seat 422 of the mounting table 420 up and down is provided at each of the four corners of the bottom face of the seat 422, the number of springs 424 or supports 425 and the arrangement thereof are not limited to those described above with reference to FIGS. 7A and 7B and FIGS. 8A and 8B. Furthermore, various changes and replacements that are made without departing from the technical spirit of the present disclosure are all encompassed by the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

((( 1)))
An image forming apparatus comprising:
a transfer unit configured to transfer an image to an object by coming into contact with the object;
a mounting table on which the object is to be mounted;
a transporting unit configured to transport the mounting table along a transport path; and
a lift capable of changing a height of the mounting table and configured to adjust the height of the mounting table in a process of image transfer to the object by the transfer unit, the lift adjusting the height of the mounting table such that a leading part, in a direction of transport, of the object mounted on the mounting table transported by the transporting unit comes into contact with the transfer unit at a position of the transport path, the position being on an upstream side in the direction of transport relative to a position where any other part of the object comes into contact with the transfer unit.
(((2)))
The image forming apparatus according to (((1))),
wherein the mounting table includes a seat on which the object is to be mounted and that is configured to change an inclination of the object in accordance with a state of contact between the object and the transfer unit.
(((3)))
The image forming apparatus according to (((2))),
wherein the seat is configured to change the inclination of the object in accordance with a force of contact of the object with the transfer unit.
(((4)))
The image forming apparatus according to (((2))) or (((3))),
wherein the seat is supported by the mounting table with an aid of an elastic member provided on a back face of the seat, the back face being opposite a face on which the object is to be mounted.
(((5)))
The image forming apparatus according to any one of (((2))) to (((4))),
wherein the seat includes:
   a body on which the object is to be mounted; and
   a spring provided at each of a plurality of positions on a back face of the body, the back face being opposite a face on which the object is to be mounted.
(((6)))
The image forming apparatus according to (((2))),
wherein the seat is configured to change the inclination of the object in such a manner as to reduce a change in a force of contact between the object and the transfer unit in the process of image transfer.
(((7)))
The image forming apparatus according to (((2))) or (((6))),
wherein the seat includes:
   a body on which the object is to be mounted; and
   a support including a height changing mechanism and provided at each of a plurality of positions on a back face of the body, the back face being opposite a face on which the object is to be mounted.
(((8)))
The image forming apparatus according to any one of (((2))) to (((7))),
wherein, with the object being mounted on the seat, if a surface of the object to which the image is to be transferred is inclined relative to a surface of the transfer unit at a transfer position, the seat changes the inclination of the object in such a manner as to reduce an inclination of the surface of the object relative to the surface of the transfer unit.
(((9)))
The image forming apparatus according to any one of (((1))) to (((8))),
wherein the transfer unit includes:
   a belt that is stretched over a plurality of rollers and that is to carry an image composed of charged particles, the belt being rotated such that a direction of movement of the belt coincides with the direction of transport of the object at a transfer position; and
   a transfer roller serving as one of the plurality of rollers and stretching the belt at the transfer position where the belt is closest to the object,
wherein the lift is configured to adjust the height of the mounting table such that the leading part of the object comes into contact with the belt at a position upstream of the transfer position in the direction of movement of the belt.
(((10)))
The image forming apparatus according to (((9))),
wherein the lift is configured to adjust the height of the mounting table such that the leading part of the object comes into contact with the belt in an area where the belt runs along the transfer roller.
(((11)))
The image forming apparatus according to (((9))),
wherein the transfer unit includes a stretching roller at a position upstream of the transfer roller in the direction of movement of the belt, the stretching roller stretching the belt in cooperation with the transfer roller; and
wherein the lift is configured to adjust the height of the mounting table such that the leading part of the object comes into contact with the belt in an area between the transfer roller and the stretching roller.
(((12)))
The image forming apparatus according to any one of (((1))) to (((8))),
wherein the transfer unit includes:
   a belt that is stretched over a plurality of rollers and that is to carry an image composed of charged particles, the belt being rotated such that a direction of movement of the belt coincides with the direction of transport of the object at a transfer position; and
   a transfer roller serving as one of the plurality of rollers and stretching the belt at the transfer position where the belt is closest to the object,
wherein the lift is configured to adjust the height of the mounting table such that the leading part of the object comes into contact with the belt at a position higher than the transfer position in the direction of movement of the belt.

What is claimed is:

1. An image forming apparatus comprising:
a transfer unit configured to transfer an image to an object by coming into contact with the object;
a mounting table on which the object is to be mounted;
a transporting unit configured to transport the mounting table along a transport path; and
a lift capable of changing a height of the mounting table and configured to adjust the height of the mounting table in a process of image transfer to the object by the transfer unit, the lift adjusting the height of the mounting table such that a leading part, in a direction of transport, of the object mounted on the mounting table transported by the transporting unit comes into contact with the transfer unit at a position of the transport path, the position being on an upstream side in the direction of transport relative to a position where any other part of the object comes into contact with the transfer unit.

2. The image forming apparatus according to claim 1,
wherein the mounting table includes a seat on which the object is to be mounted and that is configured to change an inclination of the object in accordance with a state of contact between the object and the transfer unit.

3. The image forming apparatus according to claim 2,
wherein the seat is configured to change the inclination of the object in accordance with a force of contact of the object with the transfer unit.

4. The image forming apparatus according to claim 3,
wherein the seat is supported by the mounting table with an aid of an elastic member provided on a back face of the seat, the back face being opposite a face on which the object is to be mounted.

5. The image forming apparatus according to claim 3,
wherein the seat includes:
a body on which the object is to be mounted; and
a spring provided at each of a plurality of positions on a back face of the body, the back face being opposite a face on which the object is to be mounted.

6. The image forming apparatus according to claim 4,
wherein the seat includes:
a body on which the object is to be mounted; and
a spring provided at each of a plurality of positions on a back face of the body, the back face being opposite a face on which the object is to be mounted.

7. The image forming apparatus according to claim 2,
wherein the seat is configured to change the inclination of the object in such a manner as to reduce a change in a force of contact between the object and the transfer unit in the process of image transfer.

8. The image forming apparatus according to claim 7,
wherein the seat includes:
a body on which the object is to be mounted; and
a support including a height changing mechanism and provided at each of a plurality of positions on a back face of the body, the back face being opposite a face on which the object is to be mounted.

9. The image forming apparatus according to claim 2,
wherein, with the object being mounted on the seat, if a surface of the object to which the image is to be transferred is inclined relative to a surface of the transfer unit at a transfer position, the seat changes the inclination of the object in such a manner as to reduce an inclination of the surface of the object relative to the surface of the transfer unit.

10. The image forming apparatus according to claim 1,
wherein the transfer unit includes:
a belt that is stretched over a plurality of rollers and that is to carry an image composed of charged particles, the belt being rotated such that a direction of movement of the belt coincides with the direction of transport of the object at a transfer position; and
a transfer roller serving as one of the plurality of rollers and stretching the belt at the transfer position where the belt is closest to the object,
wherein the lift is configured to adjust the height of the mounting table such that the leading part of the object comes into contact with the belt at a position upstream of the transfer position in the direction of movement of the belt.

11. The image forming apparatus according to claim 10,
wherein the lift is configured to adjust the height of the mounting table such that the leading part of the object comes into contact with the belt in an area where the belt runs along the transfer roller.

12. The image forming apparatus according to claim 10,
wherein the transfer unit includes a stretching roller at a position upstream of the transfer roller in the direction of movement of the belt, the stretching roller stretching the belt in cooperation with the transfer roller; and
wherein the lift is configured to adjust the height of the mounting table such that the leading part of the object comes into contact with the belt in an area between the transfer roller and the stretching roller.

13. The image forming apparatus according to claim 1,
wherein the transfer unit includes:
a belt that is stretched over a plurality of rollers and that is to carry an image composed of charged particles, the belt being rotated such that a direction of movement of the belt coincides with the direction of transport of the object at a transfer position; and
a transfer roller serving as one of the plurality of rollers and stretching the belt at the transfer position where the belt is closest to the object,
wherein the lift is configured to adjust the height of the mounting table such that the leading part of the object comes into contact with the belt at a position higher than the transfer position in the direction of movement of the belt.

14. An image forming apparatus comprising:
transferring means for transferring an image to an object by coming into contact with the object;
a mounting table on which the object is to be mounted;
transporting means for transporting the mounting table along a transport path; and
lifting means capable of changing a height of the mounting table for adjusting the height of the mounting table in a process of image transfer to the object by the transferring means, the lifting means adjusting the height of the mounting table such that a leading part, in a direction of transport, of the object mounted on the mounting table transported by the transporting means comes into contact with the transferring means at a position of the transport path, the position being on an upstream side in the direction of transport relative to a position where any other part of the object comes into contact with the transferring means.
